(19) United States
(12) Patent Application Publication
(10) Pub. No.: US 2020/0192896 A1
(43) Pub. Date: Jun. 18, 2020

(54) DATA PROCESSING SYSTEM

(71) Applicant: RBD Holdings Limited, London (GB)

(72) Inventors: Robert David METCALFE, Boston, MA (US); Vladimir Lowell PREDOVIC, London (GB)

(21) Appl. No.: 16/713,820

(22) Filed: Dec. 13, 2019

Related U.S. Application Data
(60) Provisional application No. 62/780,107, filed on Dec. 14, 2018.

(51) Int. Cl. G06F 16/2458; G06F 16/242; G06Q 10/06

(52) U.S. Cl. CPC G06F 16/2465; G06Q 10/0639; G06F 16/2425

(57) ABSTRACT

Systems and methods for processing data are disclosed. Methods can include receiving a plurality of data resources from one or more data sources and processing one or more of the plurality of data resources to identify a unique data identifier from one of the plurality of data resources. One or more of the plurality of data resources can be processed to identify one or more data records associated with the unique data identifier. A data sequence can be generated, the data sequence can comprise the unique data identifier and the one or more data records associated with that unique data identifier. A plurality of data sequences can be generated, each of the data sequences can comprise a unique data identifier and the one or more data records associated with that unique data identifier. The plurality of data sequences can be processed to generate a plurality of data parameter values and each of the plurality of data parameter values can be linked to a unique data identifier.

### CROSS-REFERENCE TO RELATED APPLICATIONS

This application claims the benefit of U.S. Provisional Application No. 62/780,107, filed Dec. 14, 2018, under 35 U.S.C. § 119(a). The above-referenced patent application is incorporated by reference in its entirety.

### BACKGROUND OF THE INVENTION

Obtaining data in large organisations in order to monitor and manage the performance of individuals or teams can be difficult because frequently the relevant data is held within different departments or units of an organisation, and sometimes is held within multiple organisations. The data is often held in differing technical formats and the contents of the relevant files and databases may be labelled with different labels or definitions.

### SUMMARY

According to a first aspect of the present invention, there is provided a method of processing data, the method comprising the steps of a) receiving a plurality of data resources from one or more data sources; b) processing one or more of the plurality of data resources to identify a unique data identifier from one of the plurality of data resources; c) processing one or more of the plurality of data resources to identify one or more data records associated with the unique data identifier identified in step b); d) generating a data sequence comprising the unique data identifier and the one or more data records associated with that unique data identifier; e) iterate steps b), c) and d) one or more times to generate a plurality of data sequences, each of the data sequences comprising a unique data identifier and the one or more data records associated with that unique data identifier; and f) processing the plurality of data sequences to generate a plurality of data parameter values wherein each of the plurality of data parameter values are linked to a unique data identifier.

The method may comprise the further step of allowing a user terminal to access a subset of one or more data parameter values, wherein the one or more data parameter values are associated with the user's performance. Alternatively, the method may comprise the further step of allowing a user terminal to access a subset of one or more data parameter values, wherein the one or more data parameter values are associated with the performance of a group of users.

The method may comprise the further step of generating a performance measure based on one or more data parameter values. The performance measure may be a measure which is relative to the performance of other users. The unique data identifier may be generated by combining two or more data identifiers or it may be inferred from two or more other data identifiers.

According to a second aspect of the present invention, there is provided a data carrier device comprising computer executable code for performing a any of the methods described above.

According to a third aspect of the present invention, there is provided a data processing system comprising a processor, random access memory and non-volatile data storage, the system being arranged, in use, to: i) receive a plurality of data resources from one or more data sources; ii) process one or more of the plurality of data resources to identify a unique data identifier from one of the plurality of data resources; iii) process one or more of the plurality of data resources to identify one or more data records associated with the unique data identifier identified in step b); iv) generating a data sequence comprising the unique data identifier and the one or more data records associated with that unique data identifier; v) iterate steps ii), iii) and iv) one or more times to generate a plurality of data sequences, each of the data sequences comprising a unique data identifier and the one or more data records associated with that unique data identifier; and vi) processing the plurality of data sequences to generate a plurality of data parameter values wherein each of the plurality of data parameter values are linked to a unique data identifier.

The system may further comprise a data access module wherein the plurality of data sequences are stored in the data access module. The system, may also further comprise a network interface, configured such that a user terminal may access one or more of the plurality of data sequences stored in the data access module. The data processing system may be instantiated in a cloud computing platform.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic depiction of a data processing system according to the present invention;

FIG. 2 shows a flowchart which describes a method which can be implemented by a data processing system according to the present invention;

FIG. 3 shows a graphical depiction of a user interface;

FIG. 4 shows a graphical depiction of a further user interface; and

FIG. 5 shows a schematic depiction of an implementation of a data processing system according to the present invention within a cloud computing environment

### DETAILED DESCRIPTION OF CERTAIN INVENTIVE EMBODIMENTS

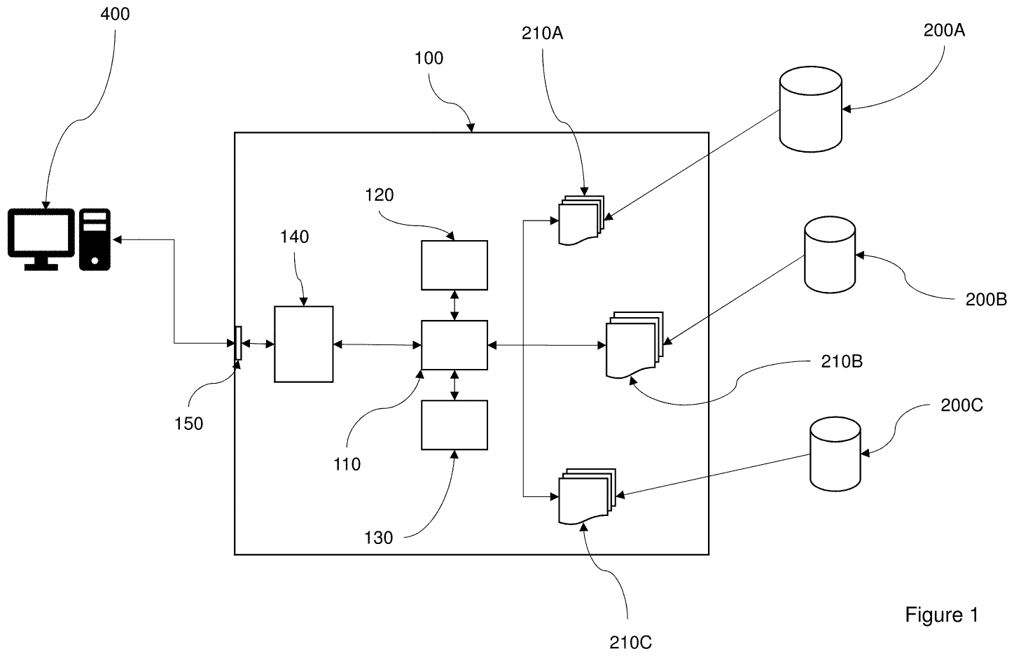

FIG. 1 shows a schematic depiction of a data processing system according to the present invention. The data processing system 100 is arranged to receive a plurality of data resources 210A, 210B, 210C from a plurality of data sources 200A, 200B, 200C. The data sources 200 may comprise different departments from within the same organisation or enterprise or they may comprise one or more different departments from a plurality of different organisations or enterprises. It will be understood that for the sake of clarity only three different data sources 200A, 200B, 200C are shown in FIG. 1 but it may be understood that in reality there may be many more data sources, each of which is sending one or more respective data resources to the data processing system. It may be understood that a data source may provide data representing one or more different departments or functions within an organisation. The data may be provided in a number of different formats. The data processing system comprises a central processing unit 110, random access memory 120 and non-volatile data storage 130. The CPU, random access memory and the non-volatile data storage are communicatively inter- connected. The data processing system further comprises data query access module 140 and a network interface 150. One or more user terminals 400 may connect to the data query access module 140 via the network interface 150.

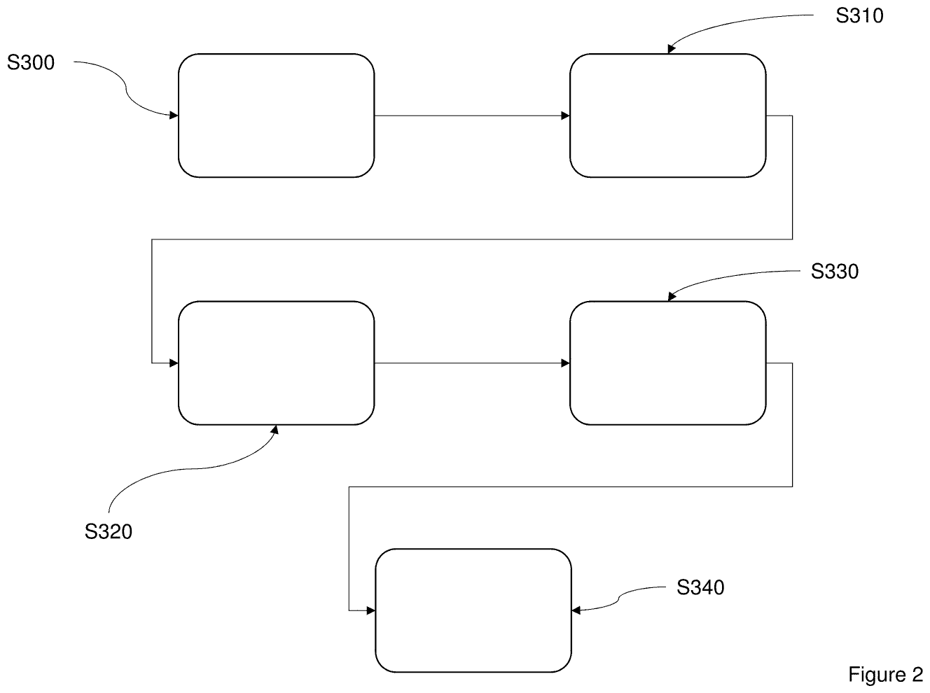

FIG. 2 shows a schematic depiction of a flowchart which describes a method which can be implemented by a data processing system 100 according to the present invention. At step S300 the data processing system 100 receives the plurality of data resources from the plurality of data sources. At step S310 the plurality of data resources are pre-processed to unify and normalise the data; subsequently at step S320 the data obtained from the pre-processing is processed to generate performance data parameter values. At step S330 the performance data parameter values are stored in a manner which enables then to be queried and at step 340 the data is exposed to enable user access.

It will be understood that in the simplest case (i.e. where the data processing system 100 is receiving at step S300 data from multiple departments within a single organisation or enterprise) then it is likely that different departments will be using different systems and applications in the course of their work. For example, the HR department is likely to use HR-specific applications when generating and processing data. Engineering and operational departments may be generating data relating to the same plant and/or equipment and the processes that the items of plant are implementing, but the data may be stored in different formats and/or applications. For a data processing system in which data is supplied by multiple organisations then it will be understood that the complexity is likely to increase significantly as the number of permutations of data application and data formats increase. In some cases, it may be possible to implement the method described above with reference to FIG. 2 using only a plurality of data resources received from a single organisation. In other cases, where the processes which are being analysed require the interaction of two or more organisations then it will be necessary to analyse data resources received from each of those organisations. The data received at step S300 may be received sequentially from each of the plurality of data sources, with each of the data sources supplying their respective data in turns. In an alternative, the data may be received in parallel from multiple data sources as this enables more efficient processing of the received data.

The set of data resources received from the data sources 200A, 200B, 200C are stored in the non-volatile data storage. At step S310 the set of data resources comprising one or more data resources will be pre-processed by the CPU. Due to the disparate provenance, data format, data structure, etc. of the data resources it will be necessary to detect a unique data identifier, which can then be used as a reference point during the further data processing and analysis. For example, where the action under analysis has been executed by a single organisation and where all of the data resources in question have come from that organisation then it is likely that there is a unique data identifier which can be used: for example, an order number, a serial number, etc. If the action under analysis depends on the interaction between two parties (and the data resources in question have come from those two organisations) then it may be that each party has an identifier which could be used. In such a case a unique data identifier can be generated by concatenating the identifier from each of the two parties.

Once the unique data identifier has been established, then each of the set of data resources can be searched to determine one or more data records which are associated with the unique data identifier. A data sequence can then be generated for the unique data identifier, the data sequence comprising the unique data identifier and the one or more associated data records. This process can be iterated to generate a plurality of data sequences, each of the plurality of data sequences comprising a unique data identifier and one or more data records associated with that unique data identifier.

At step S320 each of the data sequences are processed in order to generate one or more performance data parameter values. The performance data parameter values will be related to the implementation of a process, the execution of an operation or similar. The unique data identifier is used to identify the instance of the process or operation. The one or more performance data parameter values will be generated from the data records are associated with the unique data identifier and will provide information regarding the instance of the process or operation identified by the unique data identifier. For example, the one or more performance data parameter values may comprise data relating to the time that a process was started, the time that a process was completed, a qualitative indicator of a process outcome, a quantitative indicator of the results generated by the execution of an operation, etc. It will be understood that the nature of the performance data parameter values will be determined by the nature of the processes which are under analysis.

At step S330 the one or more performance data parameter values and the associated unique data identifier are stored in the non-volatile data storage and also in the data query access module. Then at S340 the network interface can be enabled such that an external user terminal 400 can access the data held in the data query access module.

An example of a method which can be implemented by a data processing system according to the present invention will now be given. The method is used to provide information regarding the performance of pilots in relation to their use of fuel whilst flying and the environmental impact of their performance when flying.

An airline will provide multiple data sets, which may come in many different formats, for example: CSV files, json-ordered files, http requests of aggregated flight operations data, flight plan data, flight engine raw data, other operational data, employee listings, aircraft data, pre-flight estimation plans etc. The data may be provided on a daily basis but it will be understood that it can be provided more or less frequently, based for example on the rate that the data is generated at or the amount of processing power required to perform the data processing and analysis. It may be understood that each of the data formats are likely to use differing nomenclature when referring to the same item or parameter and that even dates and times may be listed using differing formats. It is necessary to pre-process the data such that there is a common reference point. In this example, a useful reference point is a flight number (formally known as a flight designator) as this will be a unique reference which maps to a single operation of an aircraft from a first location to a second location. It will be understood that if the data for a single day is being analysed then the flight number will be a unique identifier. If the data relates to a longer period of time then it will be necessary to modify the unique data identifier by appending the date to the flight number, for example. The following discussion will assume that the data relates to a single day and that the flight number can be used as a unique data identifier.

In some data resources the data which is of interest may not be explicitly linked to the flight number. Instead, there may be references to other data identifiers which can be used to infer the flight number. For example, a data resource may refer to the time and airport of departure, the departure and arrival time of a flight, aircraft type etc. which can be used as a basis for determining the flight number. It may be necessary to compare data across multiple data resources in order to determine the flight number, which can then be used as a unique data identifier.

After each of the data sets has been received at step S300 then the pre-processing of the data sets (step S310) occurs. This pre-processing involves the determination of a set of unique data identifiers and then the subsequent identification of a plurality of data records which are associated with a respective unique data identifier. The received data sets are searched for flight numbers which can then be used as a unique data identifier. If the data has been supplied by a single code the then flight numbers will comprise the IATA alphabetic code for that airline, followed by a numerical sequence. The airline may provide a set of flight numbers which will define the unique data identifiers to be used.

When a flight number is found in a data set then the other data records that are associated with that flight number for that data set are stored. For example, an entry in a staff roster may comprise a flight number and an employee identification number for the pilot of that flight. A further record may identify the aircraft that was assigned to the flight number. Flight manifest data may indicate the total weight of the aircraft associated with the flight number, along with the estimated or measured weight of passengers, luggage, freight, fuel, etc. Engineering records may indicate technical and/or operational data relating to the flight associated with the flight number. It will be understood that there are many different sources of data which comprise data which can be associated with a single flight number.

Not every data item associated with the flight number will be needed in order to perform the required data processing. A desired set of data parameters may be supplied, for example by the airline, which need to be identified within the data resource(s) and associated with a unique data identifier.

The result of the data pre-processing step is a plurality of data sequences. Each of the data sequences comprises a unique data identifier and a one or more data records. At step S320 each of the data sequences are processed in order to generate one or more performance data parameter values. The one or more performance data parameter values are a measure of the performance of the pilot. Examples of such performance data parameters which can be generated in the context of measuring and analysing pilot performance are:
Reduced Engine Taxi In (RETI): the amount of fuel saved when a pilot turns off engines after landing when arriving at an airport is calculated
Reduced Engine Taxi Out (RETO): The amount of fuel saved when a pilot turns off one or more engines after leaving gate and before take-off. is calculated.
Efficient Flight (EF): The expected fuel use, adjusted for changes in plane weight, is calculated and compared with actual fuel use.
Fuel Load (FL): Did the pilot successfully account for changes in the Zero Fuel Weight (ZFW) of an aircraft, and then add or remove fuel appropriately?
APU Usage (APUU): Calculating the time at which the pilot turned off the auxiliary power unit after arriving at the gate.

It will be understood that these performance data parameters are exemplary and that other performance data parameters could be calculated from the data held in the plurality of data sequences determined in step S310. The calculated performance data parameter values are stored in the non-volatile data storage 130 and/or the data query access module 140 (Step S330).

At step S340 the performance data parameter values stored in the data query access module 140 are made accessible to one or more user terminals 400 via the network interface 150. Users will need to be authorised to access the data held in the data query access module so some form of access control, for example a user name and password, will be required. A user may have different levels of permission to view data (see below) and these permissions may be associated with each user. A user can be presented with the performance data parameter values calculated in step S330 or the data may be represented in a more abstract manner, for example, indicating successful performance against a threshold value, a traffic light red/amber/green rating, relative performance against peers, etc.

Examples of success in relation to the some of the performance data parameters discussed above would be that for Reduced Engine Taxi Out the fuel use for the engine which had been turned off was less than 35% of the fuel use for the main engine. For Efficient Flight, success would be that actual fuel use was less than the expected fuel use. For Fuel Load, success can be determined by the pilot adding or removing extra fuel before beginning the flight in accordance with the ZFW. The degree of success can be quantified in terms of the savings made (in terms of decreased fuel use and decreased CO₂ emissions) the reduction in unnecessary fuel weight. Success for APU Usage can be determined if the pilot turned off the aircraft's APU within a predetermined time period of the landing if external power was available. The degree of success can be quantified by the reduction in time for which the APU was active.

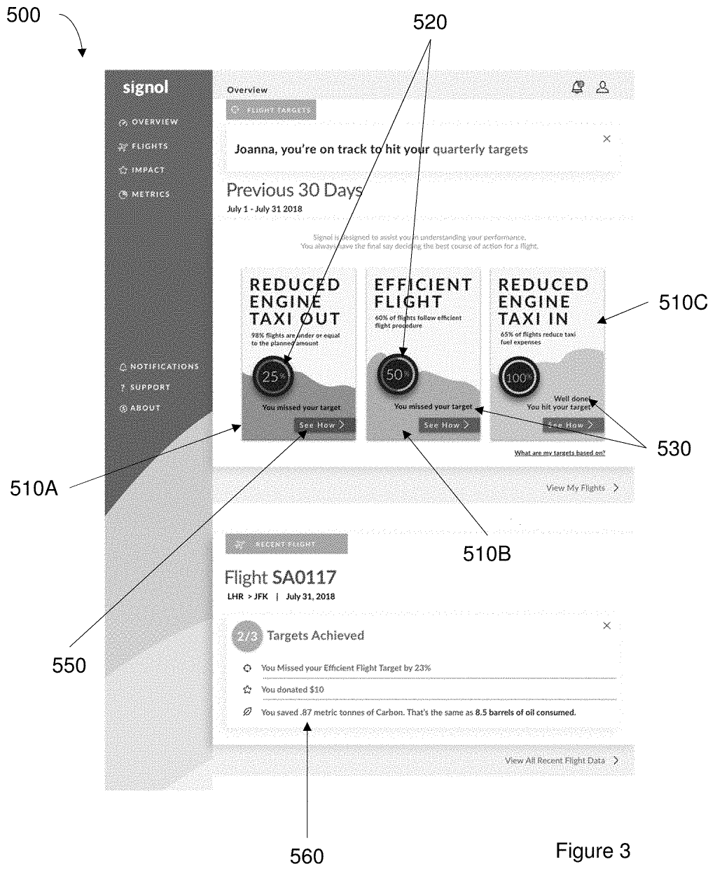

One group of users may be aircraft pilots, who will be provided with data giving feedback on their individual performance. FIG. 3 shows a graphical depiction of a user interface 500 which shows performance for a specified period of time against three performance indicators 510, in this case Reduced Engine Taxi Out (510A), Efficient Flight (510B) and Reduced Engine Taxi In (510C). The user is provided with a numerical indicator 520 as to their performance against each performance indicator, as well as information regarding whether they have met their target values or not 530. The data is presented to a user in a manner which is easy to comprehend and which can influence pilot behaviour in a positive manner. For example, a pilot may be shown how they rank compared to similar pilots for a performance indicator such that the pilot is motivated to improve performance. A pilot may be told that good performance, for example making a pre-determined reduction in CO₂ emissions, is typical of pilots who achieve job advancement, or has led to a charitable donation being made. For each of the performance indicators, the pilot may be able to select an option 550 that allows the pilot to examine the performance data parameter values. The user interface may also show performance data specific to single flight 560, which may be the pilot's most recent flight or a flight selected by the pilot. The user terminal 400 used by a pilot may be a smartphone or tablet computer which is running an app which is programmed to access the data query access module. In such a case, notifications may be sent to a pilot as specified performance thresholds or targets are achieved. When a pilot logs in to the data processing system via a user terminal then the pilot's ID may be input during the user authentication process. The received pilot ID can be used to determine which performance data parameter values relate to that pilot such that the pilot can only view data which relates to their personal performance.

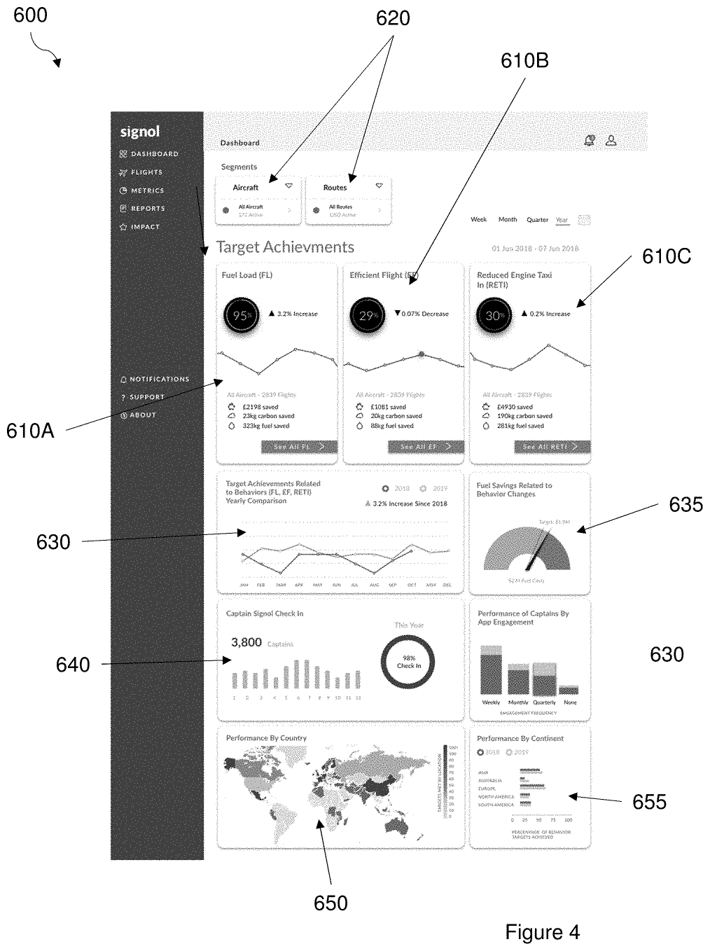

A second group of users may be managers from the airline. Whilst pilots are only able to view data which relates to their own performance, an airline manager is able to view the performance of all of the pilots for which they are responsible. Alternatively, an airline manager may be responsible for all aircraft of a particular type, all flights to (or from) a specific airport, etc. In such a case the airline manager is able to view all of the data that relates to their responsibilities. FIG. 4 shows a graphical depiction of a user interface 600 which is presented to an airline manager. The airline manager user interface is presented as a dashboard which allows airline managers to compare fuel patterns and track specific behaviours. The data presented may be configured based on the requirements of the airline. The dashboard can be customised to allow an airline manager to view standard performance indicators but also to study and analyse data so that pilot performance can be assessed and ranked. The exemplary dashboard shown in FIG. 4 displays the performance of a selected group of pilots against three performance indicators 610, in this case Zero Fuel Weight (610A), Efficient Flight (610B) and Single Engine Taxi In (610C). For each of these performance indicators there is an indication of the savings achieved by the performance, the savings being shown in terms of reductions in fuel used, reductions in CO₂ emissions and financial savings. The range of data used to generate these results can be selected by an airline manager using one or more switches 620, which allow the airline manager to select data corresponding to certain aircraft type and/or certain routes flown. The dashboard further displays variation in performance over a specified time period 630, an indication of fuel savings made 635, data regarding the number of times that pilots have accessed the system 640, 645, and data regarding the geographical variation in pilot performance against predetermined thresholds 650, 655.

Airline managers may use the dashboard to generate reports, which may be created as exportable documents. When logging in to the data processing system, an airline manager ID may be input, which may then be used to define a range of performance data parameter values that the airline manager will have access to. It will be understood that other groups of users may be able to access the performance data parameter values beyond pilots and airline managers. The responsibilities and roles of these users will define the subset of the performance data parameter values that can be accessed by them.

In an alternative, the data may be analysed to determine outliers in performance data parameter values. These outlier values represent a performance which is significantly above or below an expected range of values, indicating that the pilot's performance has been significantly better or worse than expected. Identification of the outlier values can then be used to give feedback on performance, for example providing hints or tips as to how to improve performance. The outlier performance data parameter values may be identified using an appropriate algorithm, for example cluster analysis or another form of machine learning.

The user terminal 400 may be any form of general purpose computing device. For example, it may comprise a laptop computer, tablet computer, smartphone, etc, which is running one or more software components which can interact with the network interface 150.

The data processing system 100 may be implemented using a server computer or using a cloud computing service or platform to provide the required storage and compute functionality. The data processing system may be implemented such that data sources can upload data resources to an Amazon Simple Storage Service (Amazon S3) FTP (File Transfer Protocol) enabled site. A first serverless function pre-processes the data (step S310) and then a second serverless function processes the data sequences (step S320) to generate one or more data parameter values. A third serverless function is then triggered, to populate a service API with one or more data parameter values. The purpose of this API service is to serve as a data and process cache, pre-calculating and forming the data so it is less work to be retrieved via the network interface. If under a large amount of stress from network requests, the API can leverage AWS to replicate itself and scale horizontally, reducing latency times. The result is lower latency times and a more maintainable product. It will be understood that the hardware that is used to implement a data processing system according to the present invention may take a number of different forms without departing from the scope of the invention.

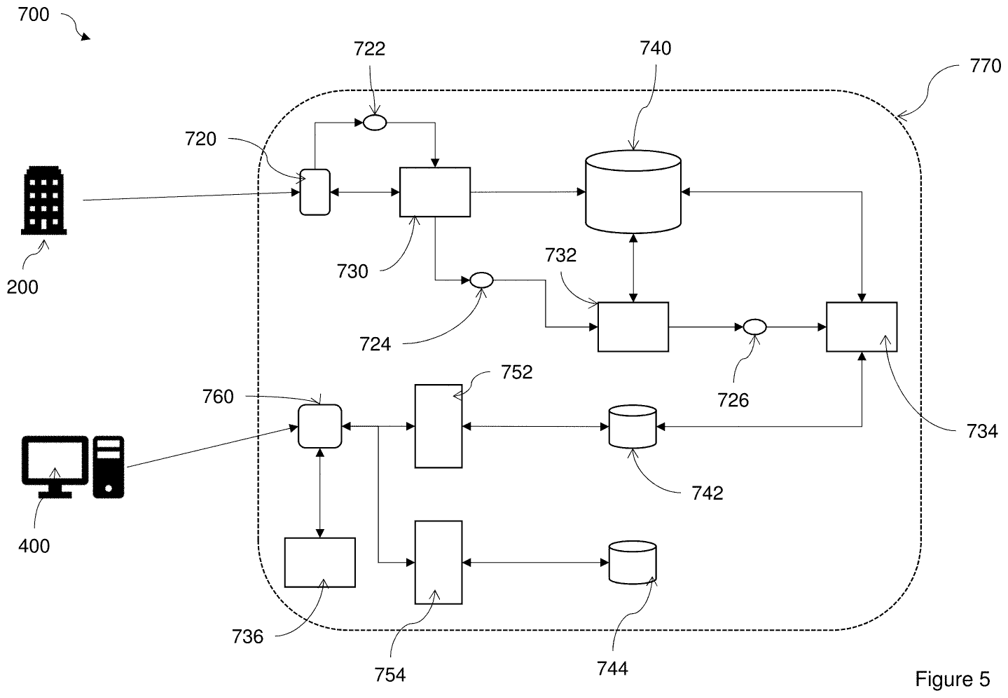

FIG. 5 shows a schematic depiction of an implementation of a data processing system 700 according to the present invention within a cloud computing environment. The specific implementation will be described with reference to the Amazon Web Services (AWS) platform but it should be understood that the system could be implemented in a similar manner using other cloud computing platforms or services.

Data is received from a data source 200, for example an airline, at an FTP server 720. The receipt of the data causes a first notification service instance 722 to cause a first serverless function 730 to retrieve the data from the FTP server and perform the data pre- processing (S310). The resulting plurality of data sequences are stored in the data warehouse 740 and a second notification service instance 724 is activated. This causes a second serverless function 732 to process the plurality of data sequences (S320) to generate one or more performance data parameter values. The one or more performance data parameter values are stored within the data warehouse 740 and a third notification service instance 726 is activated. The third notification service instance 726 causes a third serverless function 734 to store copies of the one or more performance data parameter values in a first database, which may be an AWS Relational Database Service PostgreSQL database (S330). A first virtual machine (VM) 752 extracts data from the first database and stores it within associated data storage. The system further comprises a second database 744, which may be an AWS RDS PostgreSQL database, which stores user IDs and associated authentication data. A second VM 754 extracts data from the second database and stores it within associated data storage. An API gateway 760 is in communication with the first and second VMs. When the API gateway receives an HTTPS-based request from a user terminal 400, a fourth serverless function 736 is activated. This compares the user identifier and associated credentials provided in the user request with the details stored in the second VM. If the user request is valid then it is forwarded to the first VM such that the user can view the requested data (S340). All of these entities are located within a virtual private cloud (VPC) 770 such that all of the resources which implement the system are isolated from other systems and entities.

As the present invention may be implemented on software within a conventional computing server or within a distributed computing platform, it may be understood that the invention may be made available as computer code which can be accessed via download, for example via the internet from an ISP, or on some physical media, for example, DVD, CD-ROM, USB memory stick, etc.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of processing data, the method comprising the steps of
a) receiving a plurality of data resources from one or more data sources;
b) processing one or more of the plurality of data resources to identify a unique data identifier from one of the plurality of data resources;
c) processing one or more of the plurality of data resources to identify one or more data records associated with the unique data identifier identified in step b);
d) generating a data sequence comprising the unique data identifier and the one or more data records associated with that unique data identifier;
e) iterate steps b), c) and d) one or more times to generate a plurality of data sequences, each of the data sequences comprising a unique data identifier and the one or more data records associated with that unique data identifier; and
f) processing the plurality of data sequences to generate a plurality of data parameter values wherein each of the plurality of data parameter values are linked to a unique data identifier.

2. A method according to claim 1, wherein the method comprises the further step of allowing a user terminal to access a subset of one or more data parameter values, wherein the one or more data parameter values are associated with the user's performance.

3. A method according to claim 1, where the method comprises the further step of allowing a user terminal to access a subset of one or more data parameter values, wherein the one or more data parameter values are associated with the performance of a group of users.

4. A method according to claim 1, wherein the method comprises the further step of generating a performance measure based on 1 or more data parameter values.

5. A method according to claim 4, wherein the method comprises the step of generating a performance measure relative to the performance of other users.

6. A method according to claim 1, wherein in the step b) the unique data identifier is generated by combining two or more data identifiers.

7. A method according to claim 1, wherein in the step b) the unique data identifier is inferred from two or more other data identifiers.

8. A data carrier device comprising computer executable code for performing a method according to claim 1.

9. A data processing system comprising a processor, random access memory and non-volatile data storage, the system being arranged, in use, to:
i) receive a plurality of data resources from one or more data sources;
ii) process one or more of the plurality of data resources to identify a unique data identifier from one of the plurality of data resources;
iii) process one or more of the plurality of data resources to identify one or more data records associated with the unique data identifier identified in step b);
iv) generating a data sequence comprising the unique data identifier and the one or more data records associated with that unique data identifier;
v) iterate steps ii), iii) and iv) one or more times to generate a plurality of data sequences, each of the data sequences comprising a unique data identifier and the one or more data records associated with that unique data identifier;
vi) processing the plurality of data sequences to generate a plurality of data parameter values wherein each of the plurality of data parameter values are linked to a unique data identifier.

10. A data processing system according to claim 9, wherein the system further comprises a data access module wherein the plurality of data sequences are stored in the data access module.

11. A data processing system according to claim 10, wherein the system, further comprises a network interface, configured such that a user terminal may access one or more of the plurality of data sequences stored in the data access module.

12. A data processing system according to claim 9, wherein the system is instantiated in a cloud computing platform.
